(19) United States
(12) Patent Application Publication
(10) Pub. No.: US 2025/0137649 A1
(43) Pub. Date: May 1, 2025

(54) MICROWAVE APPLIANCES AND PROTECTIVE DOOR FEATURES

(71) Applicant: Haier US Appliance Solutions, Inc., Wilmington, DE (US)

(72) Inventors: John Michael Todd, Mount Washington, KY (US); Zachary Cull, Louisville, KY (US); Chau Tran, Louisville, KY (US)

(21) Appl. No.: 18/497,522

(22) Filed: Oct. 30, 2023

(51) Int. Cl. F24C 7/08; F24C 15/02; H05B 6/64

(52) U.S. Cl. CPC F24C 7/08; F24C 15/02; H05B 6/6417

(57) ABSTRACT

A microwave oven appliance may include a cabinet, a magnetron, a control panel, a chamber door, a primary door input, a secondary unlock input, and a controller. The primary door input may be attached to the cabinet in operable communication with the chamber door to release the chamber door from the closed position. The secondary unlock input may be attached to the cabinet to selectively direct the chamber door to an unlocked state. The controller may be in operable communication with the control panel. The controller may be configured to direct a monitoring operation. The monitoring operation may include initiating a lock condition in which the chamber door is held in a locked state, detecting user engagement at the primary door input during the lock condition, determining maintenance of the lock condition, and initiating a warning command at the control panel based on determining maintenance of the lock condition.

### FIELD OF THE DISCLOSURE

The present subject matter relates generally to microwave appliances, and more particularly to features and methods for protecting doors thereof.

### BACKGROUND OF THE DISCLOSURE

Microwave oven appliances generally include a cabinet that defines a cooking chamber. The cooking chamber may receive food items for cooking. A door may be pivotally mounted to the cabinet to provide access to the cooking chamber. Microwave oven appliances generally heat food by activating an energy source, such as a magnetron, to generate cooking energy or microwaves. In order to contain the radioactive energy waves, microwave oven appliances generally have a door latch mechanism to latch the door in a closed position during cooking. Furthermore, an indication to a controller that the door is closed is typically provided to ensure that the microwave oven appliance may be operated safely.

In addition to these safeguards while the microwave oven is on, inadvertent opening of a microwave door may also be undesirable. For example, food or items inside a microwave may have an increased temperature following cooking, and inadvertent opening of the microwave door to get food or items out of the microwave oven appliance may be undesirable. In order to address such concerns, recently proposed regulations may mandate two-step procedures or systems for opening the chamber doors of various microwave appliances under certain conditions.

Although additional regulations and systems may enhance safety under certain conditions, challenges may also arise. In particular, it may be difficult to inform and educate users about the additional regulations or systems. As a result, there is potential for users to ignore the new procedures for opening the chamber door. In some cases, a user may even inadvertently damage the door or various other components of a microwave appliance.

Accordingly, it may be useful to limit access to the cooking chamber of a microwave oven appliance under certain conditions. Additionally or alternatively, a microwave or method that prevents inadvertent opening of a microwave oven appliance door would be beneficial (e.g., without risking damage to the door or an opening mechanism).

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a microwave oven appliance is provided. The microwave oven appliance may include a cabinet, a magnetron, a control panel, a chamber door, a primary door input, a secondary unlock input, and a controller. The cabinet may define a cooking chamber. The magnetron may be mounted within the cabinet in communication with the cooking chamber to direct a microwave thereto. The control panel may be mounted to the cabinet. The chamber door may be movably mounted to the cabinet to selectively restrict access to the cooking chamber in a closed position. The primary door input may be attached to the cabinet in operable communication with the chamber door to release the chamber door from the closed position. The secondary unlock input may be attached to the cabinet to selectively direct the chamber door to an unlocked state. The controller may be in operable communication with the control panel. The controller may be configured to direct a monitoring operation. The monitoring operation may include initiating a lock condition in which the chamber door is held in a locked state, detecting user engagement at the primary door input during the lock condition, determining maintenance of the lock condition, and initiating a warning command at the control panel based on determining maintenance of the lock condition.

In another exemplary aspect of the present disclosure, a method of operating a microwave oven appliance is provided. The method may include initiating a lock condition in which the chamber door is held in a locked state. The method may also include detecting user engagement at a primary door input during the lock condition. The method may further include determining maintenance of the lock condition. The method may still further include initiating a warning command at the control panel based on determining maintenance of the lock condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave oven according to exemplary embodiments of the present disclosure.

FIG. 2 provides an elevation view of a microwave oven according to exemplary embodiments of the present disclosure, wherein the door in a closed position.

FIG. 3 provides a perspective view of the exemplary microwave oven appliance of FIG. 2, wherein the door is in an open position.

FIG. 4 provides a sectional elevation view of a door release assembly according to exemplary embodiments of the present disclosure.

FIGS. 5A, 5B, 5C provide sectional elevation views illustrating movement of a door release assembly between an extended position and a retracted position according to exemplary embodiments of the present disclosure.

FIGS. 6A and 6B provide sectional elevation views illustrating movement of a door release assembly between an extended and an intermediate position. according to exemplary embodiments of the present disclosure.

FIG. 7 provides a sectional elevation view of a door release assembly according to exemplary embodiments of the present disclosure.

FIG. 8 provides a sectional elevation view of a door release assembly according to exemplary embodiments of the present disclosure.

FIGS. 9A, 9B, 9C provide schematic views illustrating movement of a door release assembly between an extended position and a retracted position according to exemplary embodiments of the present disclosure.

FIG. 10 provides a perspective view of a microwave oven according to exemplary embodiments of the present disclosure.

FIG. 11 provides an elevation view of a microwave oven according to exemplary embodiments of the present disclosure.

FIG. 12 provides a flow chart illustrating a method of operating a microwave oven appliance according to exemplary embodiments of the present disclosure.

FIG. 13 provides a flow chart illustrating a method of operating a microwave oven appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions,

The present invention advantageously provides a microwave appliance that may provide feedback for multi-step opening of a door of the microwave appliance (e.g., in accordance with UL 923 7^{th} Edition). The appliance may include features for warning a user if attempts are made to open the door before following the appropriate steps. This may advantageously prevent a user from inadvertently damaging the appliance.

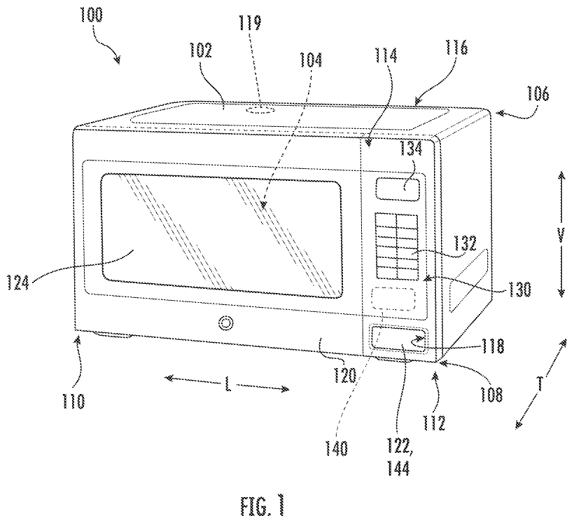

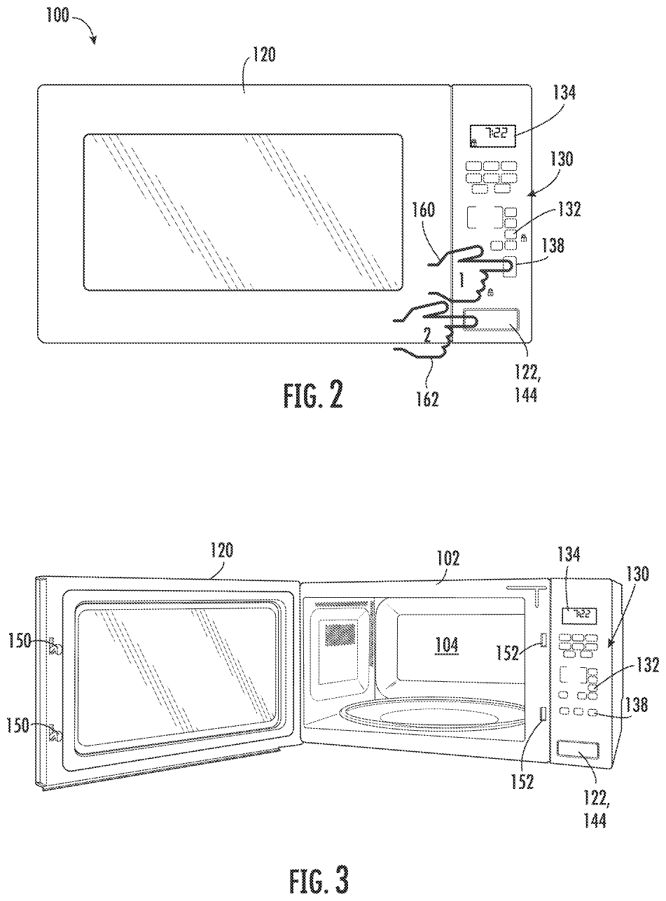

Turning now to the figures, FIG. 1 provides a front, perspective view of a microwave oven appliance (i.e., microwave or microwave oven) 100 as may be employed with the present disclosure. FIG. 2 provides an elevation view of microwave appliance oven appliance 100 with a chamber door in a closed position. FIG. 3 provides a front, perspective view of a microwave oven 100 with the door in an open position.

Microwave oven 100 generally includes an insulated cabinet 102. Cabinet 102 defines a cooking chamber 104 for receipt of food items for cooking. As will be understood by those skilled in the art, microwave oven 100 is provided by way of example only, and the present subject matter may be used in any suitable microwave oven, such as a countertop microwave oven, an over-the-range microwave oven, etc. Thus, the example embodiments detailed herein are not intended to limit the present subject matter to any particular cooking chamber configuration or arrangement.

As illustrated, microwave oven 100 generally defines a vertical direction V, a lateral direction L, and a transverse direction T, each of which is mutually perpendicular, such that an orthogonal coordinate system is generally defined. Cabinet 102 of microwave oven 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

Microwave oven 100 includes a chamber door 120 that is pivotably or rotatably attached to cabinet 102 in order to permit selective access to cooking chamber 104. As will be described in greater detail below, a separate primary door input 122 and secondary unlock input 138 are generally provided for releasing and opening the chamber door 120. The separate primary door input 122 and secondary unlock input 138 may be engaged, such as in a prescribed order for a multi-step opening procedure wherein the secondary unlock input 138 is first engaged (e.g., as indicated by hand “1” for a first user engagement action 160) and the primary door input is next engaged (e.g., as indicated by hand “2” for a second user engagement action 162). The primary door input 122 may include a door release button (e.g., slidable button 144) that selectively allows entry into cooking chamber 104 (e.g., in response to engagement or pressing of the door release button 144). In some embodiments, a handle 156 is mounted to door 120 to assist a user with opening and closing door 120 in order to access cooking chamber 104. As an example, a user can pull on the handle 156 mounted to door 120 to assist in opening or closing door 120 to access cooking chamber 104. In some embodiments, a latch or equivalent mechanism may be used to engage door 120, maintaining door 120 in a closed position until door 120 is motivated or released by primary door input 122, as will be discussed in more detail below. Glass window panes 124 may provide for viewing the contents of cooking chamber 104 when door 120 is closed and also assist with insulating cooking chamber 104.

In some embodiments, front 114 defines a body cavity 118. Body cavity 118 may be defined through front 114 and into cabinet 102 in transverse direction T. Body cavity 118 may receive a primary body of button 144.

Microwave oven 100 is generally configured to heat articles (e.g., food or beverages, within cooking chamber 104 using electromagnetic radiation). Microwave appliance 100 may include one or more heating elements 119, such as components that operate to produce the electromagnetic radiation, as is generally understood. For example, microwave appliance 100 may include a magnetron heating element 119 (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 104.

The structure and intended function of microwave ovens are generally understood by those of ordinary skill in the art and are not described in further detail herein. According to alternative embodiments, microwave oven may include one or more heating elements, such as electric resistance heating elements, induction heating elements, other microwave heating elements, halogen heating elements, or suitable combinations thereof, are positioned within cooking chamber 104 for heating cooking chamber 104 and food items positioned therein.

As shown, a control or user interface panel 130 and a user input device 132 may be positioned on an exterior of the cabinet 102. The user interface panel 130 may represent a general purpose Input/Output (“GPIO”) device or functional block. In some embodiments, the user interface panel 130 may include or be in operative communication with user input device 132, such as one or more of a variety of digital, analog, electrical, mechanical, or electro-mechanical input devices including rotary dials, control knobs, push buttons, and touch pads. The user input device 132 is generally positioned proximate to the user interface panel 130, and in some embodiments, the user input device 132 may be positioned on the user interface panel 130. The user interface panel 130 may include a feedback component 134, which may include or be provided as a digital or analog display device designed to provide visual operational feedback to a user (e.g., as would be understood). Separate from or in addition to the display device, the feedback component 134 may include or be provided as a speaker device designed to provide audible or auditory feedback from generated soundwaves (e.g., as would be understood). Additionally or alternatively, the feedback component 134 may include or be provided as a haptic device designed to provide tactile feedback from generated vibrations conveyed to a user in contact with the interface panel 130 (e.g., as would be understood).

With or separate from the control or user interface panel 130, microwave oven 100 may provide a plurality of multi-step inputs for opening or otherwise releasing chamber door 120 from the closed position. In some embodiments, the multi-step inputs include a separate primary door input 122 and a secondary unlock input 138, each attached to the cabinet 102 (e.g., directly or indirectly). Separate engagement of the primary door input 122 and secondary unlock input 138 may serve to release the chamber door 120 (e.g., under one or more predetermined conditions), as will be described in greater detail below. In particular, the secondary unlock input 138 may be provided (e.g., in operable communication with a door lock 154 or controller 140) to selectively direct the chamber door 120 to an unlocked state. The primary door input 122 may be provided (e.g., in operable communication with the chamber door 120) to release the chamber door 120 from the closed position, such as when the chamber door 120 has first been placed in the unlocked state.

Generally, microwave oven 100 may include a controller 140 in operative communication with the user input device 132 (e.g., separate from or in addition to the primary door input 122 or secondary unlock input 138). The user interface panel 130 of the microwave oven 100 may be in communication with the controller 140 via, for example, one or more signal lines or shared communication busses, and signals generated in controller 140 operate microwave oven 100 in response to user input via the user input devices 132. Input/Output (“I/O”) signals may be routed between controller 140 and various operational components of microwave oven 100. Operation of microwave oven 100 can be regulated by the controller 140 that is operatively coupled to the user interface panel 130.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of microwave oven 100, and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 140 may be constructed without using a microprocessor (e.g., using a combination of discrete analog and/or digital logic circuitry—such as switches, amplifiers, integrators, comparators, flip-flops, AND gates, and the like—to perform control functionality instead of relying upon software).

Turning further to FIGS. 2 through 4, FIG. 4 provides a sectional elevation view of an exemplary a door release assembly 142 of a microwave oven 100 to facilitate opening the chamber door 120 (e.g., moving the chamber door 120 from a closed position—FIG. 2—to an on open or otherwise non-closed position-FIG. 3). It is noted that the door release assembly 142 illustrated is merely an exemplary embodiment and, except as otherwise explicitly claimed, is not intended to limit the present disclosure to any particular mechanism. Thus, and in light of the present disclosure, one of ordinary skill would understand that any suitable embodiment for opening or releasing chamber door 120 is within the scope of the present subject matter.

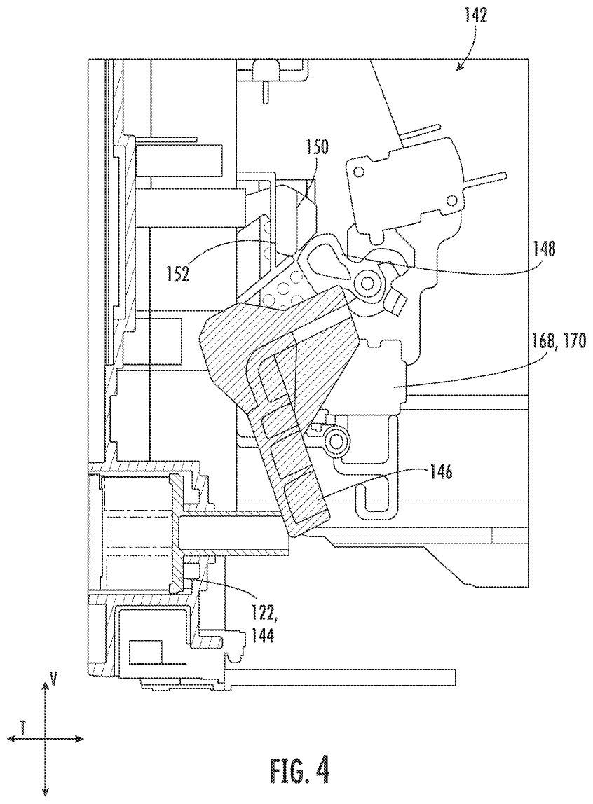

As noted above a primary door input 122 may be provided in operable (e.g., mechanical or electronic) communication with the chamber door 120, such as directly or through one or more intermediate components. In some embodiments, the primary door input 122 is provided as a slidable button 144 (e.g., as illustrated). Thus the primary door input 122 may be movable (e.g., to translate or pivot) relative to the cabinet 102. In some such embodiments, the slidable button 144 is movable between an extended position (e.g., as indicated in phantom lines at FIG. 4) and a retracted position (e.g., as indicated in solid lines at FIG. 4). As illustrated, the retracted position may provide the slidable button 144 in a relatively inward location within the cabinet 102 in comparison to the extended position. Additionally or alternatively, the retracted position may be configured to prompt movement of the chamber door 120 from the closed position, as would be understood in light of the present disclosure.

In certain embodiments, the primary door input 122 may be in mechanical communication with the chamber door 120 such that movement of the primary door input 122 is translated to the chamber door 120 (e.g., via one or more intermediate release mechanisms or drive train members). In the illustrated embodiments, the primary door input 122 is aligned with a first lever 146. Specifically, a rear portion of the slidable button 144 is in selective engagement with the first lever 146 to drive rotation of the same (e.g., as the slidable button 144 moves from the extended position to the retracted position). The illustrated first lever 146 is further in selective engagement with a second lever or gear 148, which itself is in selective engagement with one or more movable latches 150 (e.g., mounted on the chamber door 120 to hook against one or more corresponding catches 152 that are fixed to the cabinet 102) in the closed position of the chamber door 120. In turn, rotation of the first lever 146 may prompt rotation of the second lever 148, which in turn motivates movement (e.g., vertical translation) of a movable latch 150. Such movement of a movable latch 150 may serve to, for instance, lift the movable latch 150 from a corresponding catch 152, thereby releasing the chamber door 120 such that movement (e.g., pivoting) of the chamber door 120 from the closed position is permitted.

It is noted that although a slidable button 144 is illustrated, inter alia, in FIG. 4, any other suitable primary door input 122 may be provided. For instance, turning briefly to FIG. 11, primary door input 122 may be provided as a pull handle 156. As is understood, such embodiments may permit release of the chamber door 120 via the pulling motion provided by a user on the pull handle 156. As an example, the pulling motion may serve to simultaneously draw a movable biased latch to translate upwards over a corresponding static catch while the chamber door 120 moves (e.g., pivots) rearward away from the cabinet 102.

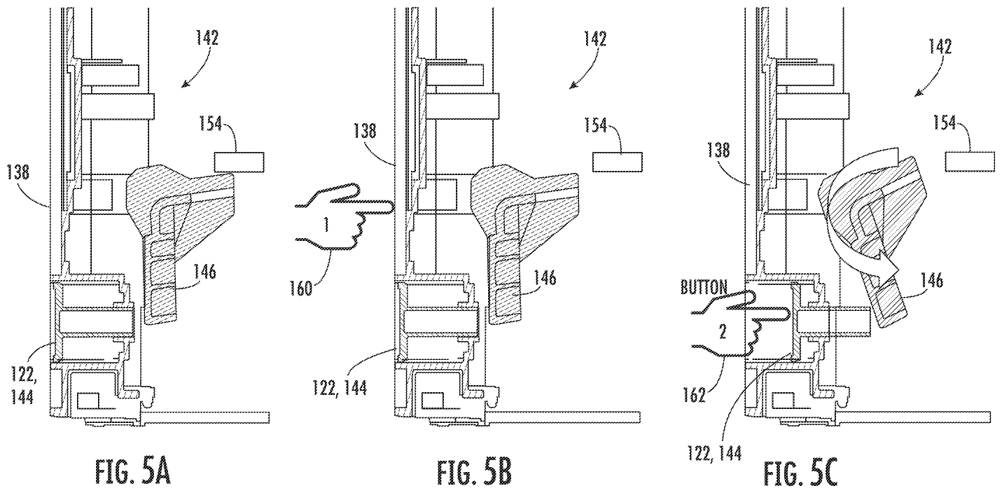

Turning now to FIGS. 5A, 5B, and 5C, various views sectional elevation views illustrating movement of a door release assembly 142 between an extended position and a retracted position. As noted above, a secondary unlock input 138 may be attached to the cabinet 102 separate from or in addition to primary door input 122. In some embodiments, the primary door input 122 is provided as an electronic button (e.g., one of user inputs 132, as illustrated and as are generally understood). The secondary unlock input 138 may be, for instance, in electrical communication with the controller 140 or a door lock 154. Thus, user engagement with the secondary unlock input 138 may prompt transmission of a corresponding signal to controller 140 or door lock 154.

Generally, the secondary unlock input 138 may be provided to direct the chamber door 120 to an unlock state in which release of the chamber door 120 is permitted. In particular, the secondary unlock input 138 may be provided to facilitate a multi-step opening procedure from the chamber door 120. Thus, user engagement of the secondary unlock input 138 may be required to be separate or distinct from user engagement of the primary door input 122. Specifically, in order to open the chamber door 120 under certain conditions, a user may be forced to follow a set procedure in which a user is required to provide a first user engagement action 160 at the secondary unlock input 138 (e.g., to release the chamber door 120 to the unlocked state from a locked state) before then providing a second user engagement action 162 at the primary door input 122 (e.g., to move the chamber door 120 from the closed position, such as to an open position).

In some embodiments, secondary unlock input 138 is provided in operable communication with a dedicated door lock 154 (e.g., directly or, alternatively, indirectly such as via controller 140). In the illustrated embodiments, the door lock 154 is movably disposed in interference engagement with the first lever 146. Specifically, the door lock 154 is movable (e.g., as directed by the controller 140 and a solenoid motor—not pictured—corresponding to the door lock 154) between a locked state (FIG. 5A) and an unlocked state (FIGS. 5B and 5C). As shown, in the locked state, the door lock 154 may prevent full actuation or movement of the first lever 146 or primary door input 122 generally. By contrast, in the unlocked state, the door lock 154 may be separated from the path of the first lever 146 or drive train connected to the primary door input 122. As described above, engagement with the secondary unlock input 138 in the form of the first user engagement action 160 may place the door release assembly 142 in the unlocked state, such as by moving the door lock 154 to the unlocked state. Subsequently, engagement with the primary door input 122 in the form of the second user engagement action 162 may drive (e.g., the first lever 146 and) chamber door 120 from the closed position.

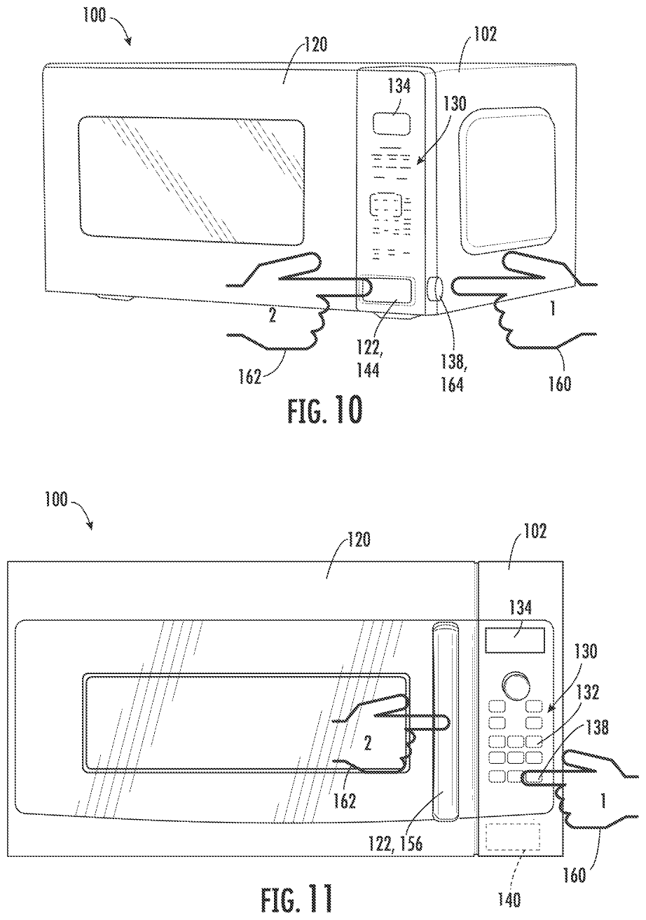

It is noted that although an electronic button is illustrated for secondary unlock input 138, inter alia, in FIG. 4, any other suitable secondary unlock input 138 may be provided. For instance, turning briefly to FIG. 10, secondary unlock input 138 may be provided as a mechanical button or input 164 (e.g., separate from user inputs 132 or in mechanical communication with door lock 154). As is understood, such embodiments may permit unlocking the chamber door 120 (e.g., without involving controller 140 or direct electrical communication in order to unlock the chamber 120). As an example, pushing the mechanical button 164 may forcibly move the internal lock (e.g., FIGS. 5A, 5B, 5C) from the locked state to the unlocked state. As would be understood a dedicated engagement switch or sensor may be provided in operable communication with the secondary unlock input 138 (e.g., to detect engagement of the same).

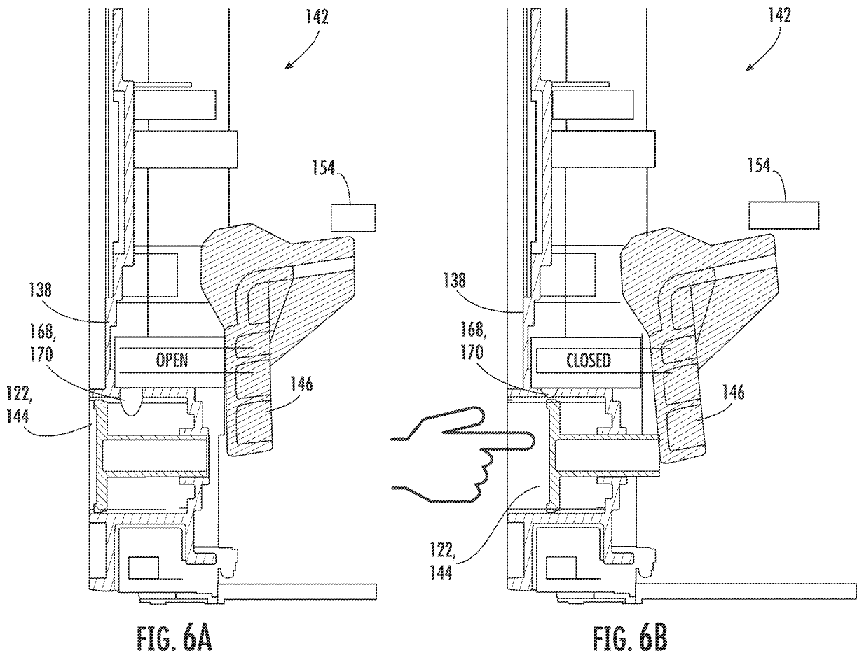

Turning now generally to FIGS. 6 through 9, various embodiments including a detection assembly 166 configured to detect user engagement of the primary door input 122 are illustrated. Notably, a user may attempt to engage the primary door input 122 prior to engaging the secondary unlock input 138 (e.g., while a lock condition is present, such as in the lock state of the door lock 154). The detection assembly 166 may advantageously provide detection of such engagement 162 (e.g., prior to the user forcing a condition or action that might damage the appliance 100).

In some embodiments, the detection assembly 166 includes an engagement sensor 168 that is attached to the cabinet 102 (e.g., directly or indirectly). Such an engagement sensor 168 may include, for instance, a contact switch or sensor, reed switch, potentiometer, piezoelectric sensor, pressure transducer, capacitive sensor, resistive sensor, magnetic field or Hall effect sensor, etc. Moreover, engagement sensor 168 may generally be configured to detect that a user has contacted the primary door input 122 or applied force to the same. In particular, the engagement sensor 168 may be configured to transmit (e.g., actively or, alternatively, passively such as by the breaking of a circuit or halting of an active signal) an engagement signal in response to any such detection.

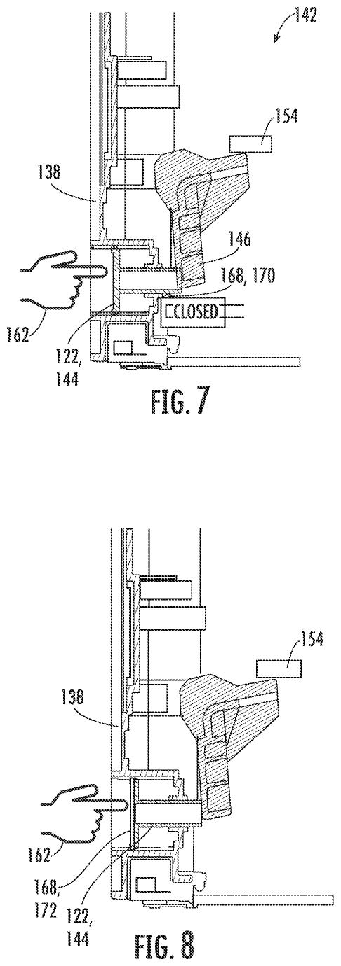

As an example, and turning especially to FIGS. 6A, 6B, and 7, the engagement sensor 168 may include or be provided as a button sensor 170 in selective communication with the slidable button 144. The button sensor 170 may be configured to detect movement from (e.g., that the slidable button 144 is no longer in) the extended position. Specifically, the button sensor 170 may be configured to detect the slidable button 144 between the extended position and the retracted position. For instance, the button sensor 170 may be disposed along the travel path defined by the slidable button 144 between the extended position and the retracted position. In some such embodiments, the button sensor 170 is generally held along in an predetermined position between the extended position and the retracted position to engage or contact at least a portion of the slidable button 144. In specific embodiments, the button sensor 170 may include or be provided as a contact sensor in selective contact with the slidable button 144 (e.g., at a button pad or stem). Such engagement or contact may be set as or for a point along the travel path that is prior to (i.e., no commensurate with or identical to) the retracted position. As noted above, one or more engagement or movement signals may be transmitted from the engagement sensor 168. For instance, engagement with the button sensor 170 may serve to close a corresponding sensor circuit (e.g., in electrical communication with controller 140 or a mated communications module (not shown) configured to transmit a movement signal to controller 140 via hard cabling, radio frequency signals (e.g., 802.11 (a). 802.11 (b), 802.11 (g), Bluetooth, or the like), infrared coupling, telephone lines and modems, or the like.

As an additional or alternative example, and turning especially to FIG. 8, the engagement sensor 168 may include or be provided as a touch sensor 172 (e.g., capacitive or resistive sensor) attached to the primary door input 122. For instance, the touch sensor 172 may be supported or disposed on a user-contact surface, such as the front facing button pad of slidable button 144 or the grip of the handle 156). As would be understood, the touch sensor 172 may generally be configured for detecting variations in an electrical field (e.g., capacitance electrical field) across the area covered by touch sensor 172. Such embodiments may be configured to analyze and identify one or more points, protrusions, or surfaces (e.g., a user's hand or finger) coming into contact with primary door input 122. In particular, variations in capacitance caused, for instance, by a user's contact or skin may prompt transmission of one or more engagement or touch signals. Optionally, touch sensor 172 may include multiple discrete (e.g., parallel) conductive wires or electrode elements arranged according to a set coordinate system array and intersecting each other at separate mutual capacitance keys. Two perpendicular electrode layers and may be joined (e.g., to one or more substrates) to facilitate directly analyzing points across an X-axis and a Y-axis. Thus, a first electrode layer including a plurality of mutually-parallel detection electrode elements extending in the same direction (e.g., vertical direction V) may be provided with a second electrode layer that may include a plurality of mutually-parallel detection electrode elements extending in the same direction (e.g., the lateral direction L) orthogonal to the direction of the first electrode layer. Both electrode layers may then be positioned adjacent to each other in attachment with a uniform substrate.

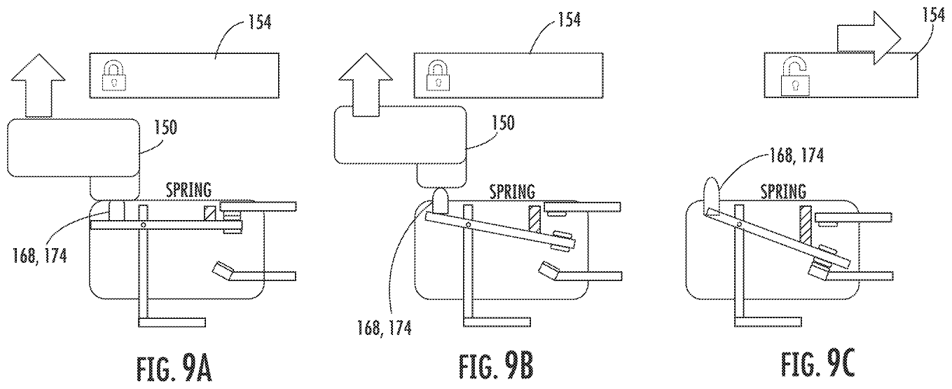

As another additional or alternative example, and turning especially to FIGS. 9A, 9B, 9C, the engagement sensor 168 may include or be provided as a latch sensor 174 in selective communication with the movable latch 150. The latch sensor 174 may be configured to detect movement from (e.g., that the movable latch 150 is no longer engaged with) the corresponding catch 152. Specifically, the latch sensor 174 may be configured to detect the movable latch 150 has moved (e.g., upward) and at least partially away from hooked engagement with the corresponding catch 152. For instance, the latch sensor 174 may be disposed along the travel path or at the resting point defined by the movable latch 150 within the cabinet 102. In some such embodiments, the latch sensor 174 is generally held along in an predetermined position within the cabinet 102 (e.g., below at least a portion of the engaged movable latch 150) to engage or contact at least a portion of the movable latch 150. In specific embodiments, the latch sensor 174 may include or be provided as a contact sensor in selective contact with the movable latch 150. Such engagement or contact may further be biased (e.g., upward) by a biasing spring or element. As noted above, one or more engagement signals may be transmitted from the engagement sensor 168. For instance, engagement between the latch sensor 174 and the movable latch 150 (FIG. 9A) may serve to close a corresponding sensor circuit (e.g., in electrical communication with controller 140 or a mated communications module (not shown)) to prevent transmission of the movement signal. Partial movement of the movable latch 150 away from the corresponding catch 152 (e.g., while the door lock 154 is in a locked state—FIG. 9B) may serve to break the circuit, thereby providing or causing transmission of the engagement signal. Optionally, full movement of the movable latch 150 away from the corresponding catch 152 (e.g., while the door lock 154 is in an unlocked state—FIG. 9C) may serve to close a corresponding sensor circuit (e.g., in electrical communication with controller 140 or a mated communications module (not shown)) to prevent transmission of the engagement signal.

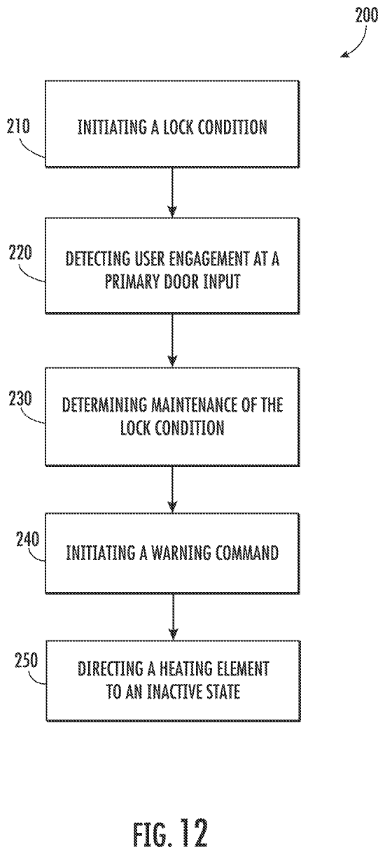

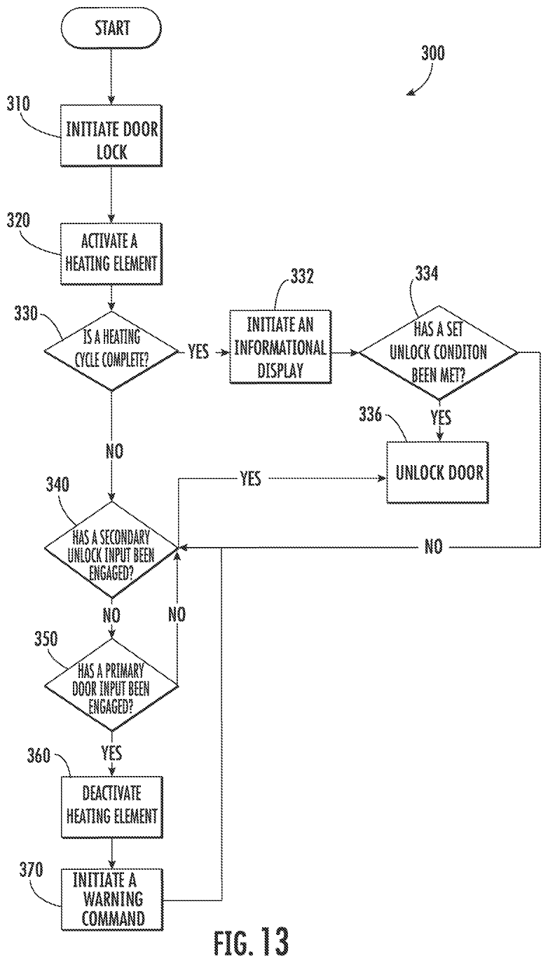

Turning now to FIGS. 12 and 13, the present disclosure may further be directed to algorithms or methods (e.g., method 200 or 300) of operating a microwave oven appliance, such as microwave oven 100. In exemplary embodiments, the controller 140 may be operable to perform various steps of an algorithm or method in accordance with the present disclosure.

The algorithms or methods (e.g., 200 or 300) may occur as, or as part of, a monitoring operation of microwave oven 100. In particular, the algorithms or methods (e.g., 200 or 300) disclosed herein may advantageously detect potentially damaging conditions, prevent damage to the appliance 100, or guide a user through a particular procedure for opening a chamber door 120.

It is noted that the order of steps within algorithms or methods 200 and 300 are for illustrative purposes. Moreover, none of the algorithms or methods 200 and 300 are mutually exclusive. In other words, algorithms or methods within the present disclosure may include one or more of algorithms or methods 200 and 300. All may be adopted or characterized as being fulfilled in a common operation. Except as otherwise indicated, one or more steps in the below algorithms or methods 200 or 300 may be changed, rearranged, performed in a different order, or otherwise modified without deviating from the scope of the present disclosure.

Turning especially to FIG. 12, at 210, the method 200 includes initiating a lock condition in which the chamber door is held in a locked state. For instance, the chamber door may be provided in the closed position. The door lock may be provided in the locked state. Optionally, the heating element (e.g., magnetron or any additional electrical heating elements, such as a resistive heating element, radiant heating element, induction heating element, etc.) of the microwave oven appliance may be activated, such as part of a heating cycle. In some such embodiments, the lock condition or heating cycle may be prompted or initiated in response to a user-selected heating cycle (e.g., input at the control panel).

At 220, the method 200 includes detecting user engagement at the primary door input during the lock condition. Such a detection may occur, for instance, while the heating cycle is ongoing or within a predetermined time following completion of the heating cycle. In some embodiments, 220 includes receiving an engagement signal from the engagement sensor (e.g., as described above). Optionally, detection may occur before the primary door input is fully engaged.

At 230, the method 200 includes determining maintenance of the lock condition. Thus, it may be determined (e.g., directly or indirectly) that the secondary unlock input has not been received, such as might otherwise occur in response to receiving an input signal from the secondary unlock input (e.g., or from a sensor or switch corresponding to the same). In particular, the secondary unlock input detection may not be received prior to 220. In turn, it may be determined that a user has attempted to open the door without following the predetermined multi-step opening procedure.

At 240, the method 200 includes initiating a warning command at the control or user interface panel (e.g., based on or in direct response to 220 or 230). In particular, the warning command may include a visual display or an audible alert at the control panel. As an example, and as would be understood, the display element may change, illuminate, or present an icon or message indicating that the multi-step opening procedure for opening the chamber door was not followed. As an additional or alternative example, the secondary unlock input may be illuminated (e.g., by a corresponding backlit light source) to draw a user's attention to the prerequisite input or step for opening the chamber door. As another additional or alternative example, an audible alert noise or message may be generated at a speaker element (e.g., as is generally understood) to indicate that the multi-step opening procedure for opening the chamber door was not followed.

At 250, the method 200 includes directing the heating element to an inactive state (e.g., either from the active state or, alternatively, to remain in the inactive state if already being in the inactive state immediately prior to 250). Optionally, 250 may occur while maintaining the lock condition (e.g., locked state). Additionally or alternatively, 250 may be based on or in response to 220 or 230. Thus, any heating cycle may be halted, for instance, in tandem with the warning command of 240.

Turning especially to FIG. 13, at 310, the method 300 includes initiating a door lock. For instance, 310 may include initiating a lock condition in which the chamber door is held in a locked state. Specifically, the chamber door may be provided in the closed position and the door lock may be provided in the locked state. In some such embodiments, the lock condition or heating cycle may be prompted or initiated (e.g., automatically) in response to a user-selected heating cycle (e.g., input at the control panel).

At 320, the method 300 includes activating a heating element (e.g., magnetron or any additional electrical heating elements, such as a resistive heating element, radiant heating element, induction heating element, etc.), such as part of a heating cycle. Such heating element activation is generally understood and may be in accordance with known methods of microwave cooking.

At 330, the method 300 includes evaluating a heating cycle. Specifically, it may be determined if the heating cycle of 320 is complete. If complete, the method 300 may proceed to 332. If the heating cycle is not complete, though, the method 300 may proceed to 340.

At 332, the method 300 includes initiating an informational display. For instance, the display element may change, illuminate, or present an icon or message indicating that the heating cycle is complete.

At 334, the method 300 includes evaluating a set unlock condition. For instance, it may be determined if a set unlock condition has been met. Such an unlock condition may be, for instance, tied to expiration of a predetermined time interval (e.g., fixed time interval) or formula following the completion of the heating cycle. If complete, the method 300 may proceed to 336. If not complete, the method 300 may proceed to 340.

At 336, the method 300 includes unlocking the chamber door. In other words, the door look may be moved to the unlocked state. Thus, the chamber door may be permitted to open (e.g., in response to user engagement with the primary door input).

At 340, the method 300 includes evaluating the secondary unlock input. Specifically, it may be determined if the first user-engagement action has occurred at the secondary unlock input (e.g., as described above based on a signal—or the absence thereof—from the secondary unlock input). If the secondary unlock input has been engaged, the method 300 may proceed to 336. If the secondary unlock input has not been engaged, though, the method 300 may proceed to 350.

At 350, the method 300 includes evaluating the primary door input. Specifically, it may be determined if the second user-engagement action has occurred at the primary door input (e.g., as described above based on a signal—or the absence thereof—from the primary door input). If the primary door input has been engaged (e.g., prior to the secondary unlock input being engaged), the method 300 may proceed to 360. If the primary door input has not been engaged, though, the method 300 may return to 340.

At 360, the method 300 includes deactivating the heating element. For instance, 360 may include directing the heating element to an inactive state (e.g., either from the active state or, alternatively, to remain in the inactive state). Optionally, 360 may occur while maintaining the lock condition. Additionally or alternatively, 360 may be based on or in response to 350 (e.g., a determination that the primary door input has been engaged).

At 370, the method 300 includes initiating a warning command at the control or user interface panel (e.g., based on or in direct response to 350 or 360). In particular, the warning command may include a visual display or an audible alert at the control panel. As an example, and as would be understood, the display element may change, illuminate, or present an icon or message indicating that the multi-step opening procedure for opening the chamber door was not followed. As an additional or alternative example, the secondary unlock input may be illuminated (e.g., by a corresponding backlit light source) to draw a user's attention to the prerequisite input or step for opening the chamber door. As another additional or alternative example, an audible alert noise or message may be generated at a speaker element (e.g., as is generally understood) to indicate that the multi-step opening procedure for opening the chamber door was not followed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A microwave oven appliance comprising:
a cabinet defining a cooking chamber;
a magnetron mounted within the cabinet in communication with the cooking chamber to direct a microwave thereto;
a control panel mounted to the cabinet;
a chamber door movably mounted to the cabinet to selectively restrict access to the cooking chamber in a closed position;
a primary door input attached to the cabinet in operable communication with the chamber door to release the chamber door from the closed position;
a secondary unlock input attached to the cabinet to selectively direct the chamber door to an unlocked state; and
a controller in operable communication with the control panel, the controller being configured to direct a monitoring operation comprising
initiating a lock condition in which the chamber door is held in a locked state,
detecting user engagement at the primary door input during the lock condition,
determining maintenance of the lock condition, and
initiating a warning command at the control panel based on determining maintenance of the lock condition.

2. The microwave oven appliance of claim 1, wherein the primary door input comprises a slidable button,
wherein the microwave oven appliance further comprises a button sensor in selective communication with the slidable button, and
wherein detecting user engagement at the primary door input comprises receiving an engagement signal from the button sensor.

3. The microwave oven appliance of claim 2, wherein the slidable button is movable between an extended position and a retracted position, the retracted position being configured to prompt movement of the chamber door from the closed position, and
wherein the button sensor is configured to detect the slidable button between the extended position and the retracted position.

4. The microwave oven appliance of claim 3, wherein the button sensor comprises a contact sensor in selective contact with the slidable button.

5. The microwave oven appliance of claim 1, wherein the microwave oven appliance further comprises a touch sensor disposed on the primary door input, and wherein detecting user engagement at the primary door input comprises receiving an engagement signal from the touch sensor.

6. The microwave oven appliance of claim 1, further comprising:
a door lock in mechanical communication with the chamber door, the door lock being movable between a locked state restricting movement of the chamber door from the closed position and the unlocked state permitting movement of the chamber door from the closed position,
wherein the secondary unlock input is attached to the cabinet in operable communication with the door lock to selectively direct the door lock to move the door lock from the locked state to the unlocked state.

7. The microwave oven appliance of claim 1, wherein the primary door input comprises a pull handle.

8. The microwave oven appliance of claim 1, wherein the monitoring operation further comprises:
directing a heating element to an inactive state while maintaining the lock condition in response to detecting user engagement at the primary door input.

9. The microwave oven appliance of claim 1, wherein the warning command comprises a visual display or an audible alert at the control panel.

10. A method of operating a microwave oven appliance comprising a cabinet, a control panel, and a chamber door, the method comprising:
initiating a lock condition in which the chamber door is held in a locked state;
detecting user engagement at a primary door input during the lock condition;
determining maintenance of the lock condition; and
initiating a warning command at the control panel based on determining maintenance of the lock condition.

11. The method of claim 10, wherein the microwave oven appliance further comprises a slidable button and a button sensor in selective communication with the slidable button, and
wherein detecting user engagement at the primary door input comprises receiving an engagement signal from the button sensor.

12. The method of claim 11, wherein the slidable button is movable between an extended position and a retracted position, the retracted position being configured to prompt movement of the chamber door from a closed position, and
wherein the button sensor is configured to detect the slidable button between the extended position and the retracted position.

13. The method of claim 12, wherein the button sensor comprises a contact sensor in selective contact with the slidable button.

14. The method of claim 10, wherein the microwave oven appliance further comprises a touch sensor disposed on the primary door input, and
wherein detecting user engagement at the primary door input comprises receiving an engagement signal from the touch sensor.

15. The method of claim 10, wherein the microwave oven appliance further comprises a door lock in mechanical communication with the chamber door, the door lock being movable between a locked state restricting movement of the chamber door from a closed position and an unlocked state permitting movement of the chamber door from the closed position,
wherein a secondary unlock input is attached to the cabinet in operable communication with the door lock to selectively direct the door lock to move the door lock from the locked state to the unlocked state.

16. The method of claim 10, wherein the primary door input comprises a pull handle.

17. The method of claim 10, further comprising:
directing a heating element to an inactive state while maintaining the lock condition in response to detecting user engagement at the primary door input.

18. The method of claim 10, wherein the warning command comprises a visual display or an audible alert at the control panel.
